(19) United States
(12) Patent Application Publication
(10) Pub. No.: US 2015/0030176 A1
(43) Pub. Date: Jan. 29, 2015

(54) EARPHONE

(71) Applicant: Bill Yang, Taipei City (TW)

(72) Inventor: Bill Yang, Taipei City (TW)

(73) Assignee: COTRON CORPORATION, Taipei City (TW)

(21) Appl. No.: 14/340,584

(22) Filed: Jul. 25, 2014

(30) Foreign Application Priority Data
Jul. 26, 2013 (CN) 201310319707.4

(51) Int. Cl. H04R 1/10

(52) U.S. Cl. CPC H04R 1/1041
USPC 381/74

(57) ABSTRACT

An earphone including an earphone body, a photosensitive switch, a power supplier and a light emitter is provided. The photosensitive switch, the power supplier and the light emitter are disposed on the earphone body. The light emitter is electrically connected to power supplier through the photosensitive switch.

### CROSS-REFERENCE TO RELATED APPLICATION

This application claims the priority benefit of China application serial no. 201310319707.4, filed on Jul. 26, 2013. The entirety of the above-mentioned patent application is hereby incorporated by reference herein and made a part of this specification.

### BACKGROUND

1. Field of the Invention

The invention is directed to a headphone and more particularly, to a headphone having a light emitter.

2. Description of Related Art

With the continuous progress in technology, all electronic products have been developed towards light, handy and miniaturized designs. For the sake of conveniently listening to sound information provided by electronic products without disturbing other people around, people may use miniaturized electronic products, such that an earphone has become a necessary accessory to the electronic product. Moreover, the earphone also provides a listener with better audio transmission so that the listener can clearly hear and understand content of the audio information. In contrast to unclear audio transmission through the air, especially when the listener is moving, for example like doing exercises, driving, intensely moving around or being in a noisy environment, the audio transmission of the earphone still would not be affected.

### SUMMARY

The invention provides an earphone which can resolve an issue that a convention earphone is incapable of light-emitting.

The invention is directed to an earphone including an earphone body, a photosensitive switch, a power supplier and a light emitter. The photosensitive switch, the power supplier and the light emitter are disposed on the earphone body. The light emitter is electrically connected to power supplier through the photosensitive switch.

In an embodiment of the invention, the earphone further includes a manual switch, where the photosensitive switch is electrically connected to the power supplier through the manual switch.

In an embodiment of the invention, the earphone further includes a manual switch, where the light emitter is electrically connected to the power supplier through the manual switch.

In an embodiment of the invention, the light emitter is an electroluminescent element or a light-emitting diode (LED).

In an embodiment of the invention, the earphone body includes two earcup bodies and a strap. Two ends of the strap are connected with the two earcup bodies, and the light emitter is disposed on at least one of the two earcup bodies and the strap.

In an embodiment of the invention, sensitivity of the photosensitive switch is adjustable.

To sum up, the earphone of the invention has the light emitter capable of decorating or warning.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of an earphone according to an embodiment of the invention.

FIG. 2 is a schematic block diagram of an earphone according to another embodiment of the invention.

FIG. 3 is a schematic block diagram of an earphone according to yet another embodiment of the invention.

FIG. 4 is a schematic diagram of an appearance of an earphone according to an embodiment of the invention.

### DESCRIPTION OF EMBODIMENTS

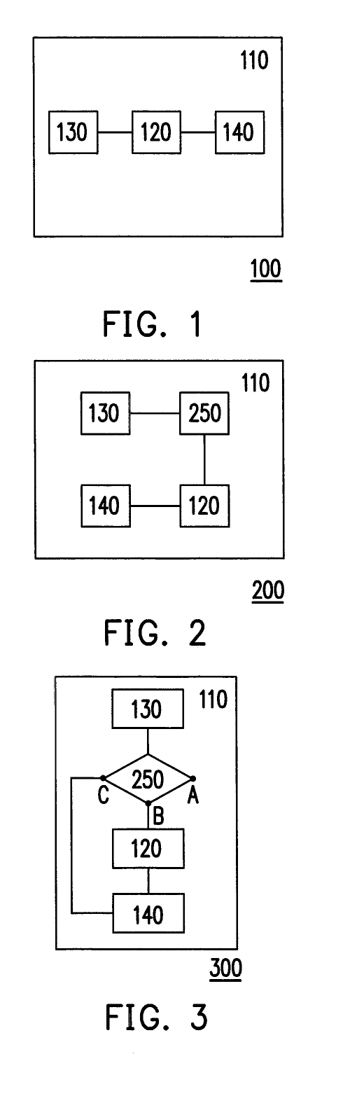

FIG. 1 is a schematic block diagram of an earphone according to an embodiment of the invention. With reference to FIG. 1, an earphone 100 of the present embodiment may be a wireless headset (an earphone with a microphone) or a wired headset used for one ear, a wired or wireless in-ear or circumaural type earphone or any other type earphone used for both ears. The earphone 100 includes an earphone body 110, a photosensitive switch 120, a power supplier 130 and a light emitter 140. The photosensitive switch 120, the power supplier 130 and the light emitter 140 are disposed on the earphone body 110. As described above, the earphone 100 may be various types, and thus, the earphone body 110 may vary with the type of the earphone 100. The photosensitive switch 120, the power supplier 130 and the light emitter 140 may be located separately from or near one another on the earphone body 110, which are not limited in the invention.

The light emitter 140 is electrically connected to power supplier 130 through the photosensitive switch 120. In a scenario where luminance of external light sensed by the photosensitive switch 120 is sufficient, the photosensitive switch 120 keeps the light emitter 140 being disconnected from the power supplier 130. Thus, the light emitter 140 is incapable of obtaining power supplied by the power supplier 130 and does not emit light. In a scenario where the luminance of the external light sensed by the photosensitive switch 120 is insufficient, the photosensitive switch 120 induces conduction between the light emitter 140 and the power supplier 130. Thus, the light emitter 140 can obtain the power supplied by the power supplier 130 to emit light. In this way, the light emitter 140 on the earphone body 110 can emit light or be turned off automatically according to the change of the ambient luminance, so as to not only provide the user of the earphone 100 with caution light for safety, but also to be used for the appearance style of the user.

In the present embodiment, the light emitter 130 may be an electroluminescent element or a light emitting diode (LED), the power supplier 130 may be a battery storing electricity, a solar cell or an element obtaining power from a player connected with the earphone 100. Sensitivity of the photosensitive switch 120 is adjustable, so as to conform to usages of different users. Additionally, when emitting the light, the light emitter 130 may continuously light or intermittently light, regularly or irregularly, with changeable luminance. The light emitter 130 brings a warning or decorating effect. Moreover, the light emitter 130 may be designed to light with the rhythm of music being played by the earphone 100. The aforementioned lighting modes can be achieved only by the use of a common controller, and thus, description regarding the controller is omitted herein.

FIG. 2 is a schematic block diagram of an earphone according to another embodiment of the invention. With reference to FIG. 2, an earphone 200 of the present embodiment is similar to the earphone 100 illustrated in FIG. 1 and different therefrom in that the earphone 200 of the present embodiment further includes a manual switch 250. The photosensitive switch 120 is electrically connected to power supplier 130 through the manual switch 250. Through the manual switch 250, a user may select whether to activate the light emitter 140 by the photosensitive switch 120, such that the user may select a mode for use according to the occasion.

FIG. 3 is a schematic block diagram of an earphone according to yet another embodiment of the invention. With reference to FIG. 3, an earphone 300 of the present embodiment is similar to the earphone 200 illustrated in FIG. 2 and different therefrom in that the light emitter 140 of the earphone 300 of the present embodiment is electrically connected to power supplier 130 through the manual switch 250. The manual switch 250 of the present embodiment is a three-stage switch. When the manual switch 250 is switched to an output terminal A, the power supplied by the power supplier 130 is incapable of being output to the light emitter 140 or the photosensitive switch 120. When the manual switch 250 is switched to an output terminal B, the power supplier 130 is conducted with the photosensitive switch 120 through the manual switch 250 and activates the light emitter 140 according to a result of the photosensitive switch 120 sensing the ambient luminance. When the manual switch 250 is switched to an output terminal C, the power supplied by the power supplier 130 may be directly output to the light emitter 140 through the manual switch manual switch 250, such that the light emitter 140 is maintained in the light-emitting state. Therefore, the user may select to directly conduct the light emitter 140 with the power supplier 130 by employing the manual switch 250. In other words, the user may keep the light emitter 140 in the light-emitting state through the manual switch 250.

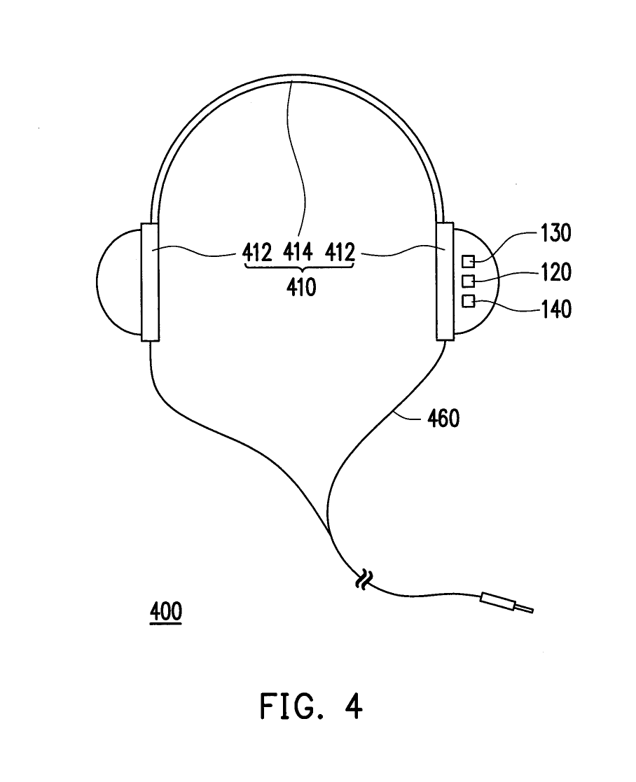

FIG. 4 is a schematic diagram of an appearance of an earphone according to an embodiment of the invention. With reference to FIG. 4, an earphone 400 of the present embodiment applies the structure of the earphone 100 illustrated in FIG. 1. In the present embodiment, an earphone body 410 includes two earcup bodies 412 and a strap 414. Two ends of the strap 414 are connected with the two earcup bodies 412. In other words, the earphone body 410 defined herein refers to an assembly including all elements of an earphone available on the market. The earphone body 410 of the present embodiment further includes an audio line 460 electrically connected with the two earcup bodies 412. In the present embodiment, the photosensitive switch 120, the power supplier 130 and the light emitter 140 are all disposed on one of the earcup bodies 412. However, the light emitter 140 may also be disposed on both of the earcup bodies 412, only disposed on the strap 414, disposed on one of the earcup bodies 412 and the strap 414, or disposed on both of the earcup bodies 412 and the strap 414. In brief, the light emitter 140 may be disposed on one or more places as long as being disposed on the earphone body 410. Similarly, as long as the photosensitive switch 120 and the power supplier 130 are disposed on the earphone body 410, it does not matter whether they are disposed on the earcup bodies 412 or the strap 414.

In the present embodiment, the earphone 400 is a wired circumaural type, for example, but the earphone of the invention may by other types and causes no affection to the usage of the earphone of the invention that the photosensitive switch and the light emitter are employed for decoration and warning functions.

In view of the foregoing, the earphone of the invention is equipped with the photosensitive switch and the light emitter, such that the photosensitive switch can activate the light emitter to provide variations of light. Thereby, the earphone can provide not only variety for the style of the user, but also a warning function by employing the light provided from the light emitter, such that personal security of the user can be protected.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An earphone, comprising:
an earphone body;
a photosensitive switch, disposed on the earphone body;
a power supplier, disposed on the earphone body; and
a light emitter, disposed on the earphone body and electrically connected to the power supplier through the photosensitive switch.

2. The earphone according to claim 1, further comprising:
a manual switch, wherein the photosensitive switch is electrically connected to the power supplier through the manual switch.

3. The earphone according to claim 1, further comprising:
a manual switch, wherein the light emitter is electrically connected to the power supplier through the manual switch.

4. The earphone according to claim 1, wherein the light emitter is an electroluminescent element or a light-emitting diode (LED).

5. The earphone according to claim 1, wherein the earphone body comprises:
two earcup bodies; and
a strap, having two ends connected with the earcup bodies, and the light emitter being disposed on at least one of the two earcup bodies and the strap.

6. The earphone according to claim 1, wherein sensitivity of the photosensitive switch is adjustable.
